(19) United States
(12) Patent Application Publication
(10) Pub. No.: US 2012/0250083 A1
(43) Pub. Date: Oct. 4, 2012

(54) DATA PROCESSING APPARATUS, DATA PROCESSING METHOD, AND STORAGE MEDIUM STORING A PROGRAM

(75) Inventor: Kazufumi Kobashi, Tokyo (JP)

(73) Assignee: CANON KABUSHIKI KAISHA, Tokyo (JP)

(21) Appl. No.: 13/410,863

(22) Filed: Mar. 2, 2012

(30) Foreign Application Priority Data
Apr. 1, 2011 (JP) 2011-082190

(51) Int. Cl. G06K 15/02; G06F 3/12

(52) U.S. Cl. 358/1.15

(57) ABSTRACT

A data processing apparatus combines a plurality of files selected by a user to generate a single file, generates a job for image processing to be executed on the single file, based on the generated single file, and sets identification information identifying the job as attribute information of each of the plurality of files.

### BACKGROUND OF THE INVENTION

1. Field of the Invention

The present invention relates to a data processing apparatus for processing an image processing job, a data processing method, and a storage medium storing a program.

2. Description of the Related Art

Heretofore, a system that spools the rendering commands of a plurality of applications as intermediate code data, combines the spooled pieces of intermediate code data as a single job, and outputs the single job to a multifunction peripheral is known (Japanese Patent Laid-Open No. 2001-134407). Also known is a system that, at the time of printing, analyzes page information of electronic data to be printed, extracts the character strings of print job name candidates, and selects an arbitrary character string from the extracted character strings (Japanese Patent Laid-Open No. 2010-113595).

However, in neither of the cited references is the job associated with the pieces of application data that were combined, after the plural pieces of application data have been combined and output as a single job. Accordingly, it is not possible, for example, to retrieve the pieces of application data that were combined, based on job names displayed in the transmission history.

### SUMMARY OF THE INVENTION

An aspect of the present invention is to eliminate the above-mentioned problems with the conventional technology. The present invention provides a data processing apparatus that, in the case where a job is generated by combining a plurality of image processing files to generate a single file, associates the job with each of the files that were combined, a data processing method, and a storage medium storing a program.

The present invention in its first aspect provides a data processing apparatus that executes image processing on a file, comprising: a file generating unit configured to combine a plurality of files selected by a user to generate a single file; a first setting unit configured to set identification information with respect to the single file generated by the file generating unit; and a second setting unit configured to set the identification information with respect to each of the plurality of files that are combined.

The present invention in its second aspect provides a data processing method executed in a data processing apparatus that executes image processing on a file, comprising: a file generating step of combining a plurality of files selected by a user to generate a single file; a first setting step of setting identification information with respect to the single file generated in the file generating step; and a second setting step of setting the identification information with respect to each of the plurality of files that are combined.

The present invention in its third aspect provides a storage medium storing a program for executing image processing on a file, the program causing a computer to execute: a file generating step of combining a plurality of files selected by a user to generate a single file; a first setting step of setting identification information with respect to the single file generated in the file generating step; and a second setting step of setting the identification information with respect to each of the plurality of files that are combined.

According to the present invention, in the case where a job is generated by combining a plurality of image processing files to generate a single file, the job can be associated with each of the files that were combined.

Further features of the present invention will become apparent from the following description of exemplary embodiments with reference to the attached drawings.

### BRIEF DESCRIPTION OF THE DRAWINGS

FIG. 1 is a diagram showing the overall configuration of a data processing system.

FIG. 2 is a block diagram showing the hardware configuration of a data processing apparatus.

FIG. 3 is a block diagram showing the hardware configuration of an image processing apparatus.

FIG. 4 is a block diagram showing the software configuration of the data processing apparatus.

FIG. 5 is a diagram for illustrating word processing in the data processing apparatus.

FIG. 6 is a diagram showing a screen for selecting a plurality of files.

FIG. 7 is a diagram for illustrating the data structure of a binder.

FIG. 8 is a diagram showing a screen for setting the sequence in which to combine a plurality of files.

FIG. 9 is a diagram showing a warning screen when a document cannot be imported.

FIG. 10A and 10B are flowcharts showing a procedure of data processing by the data processing apparatus.

FIG. 11 is a diagram showing output icon settings information.

FIG. 12 is a diagram showing a screen for setting a job name.

FIG. 13 is a diagram showing a warning screen when a job name cannot be stored in a property.

FIG. 14 is a diagram showing a fax settings screen.

FIG. 15 is a diagram showing a screen for designating a save destination of a job name.

FIG. 16 is a diagram showing a fax transmission settings screen.

FIG. 17 is a flowchart showing an exemplary procedure of search processing.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals are given to the same constituent elements, and redundent description thereof is omitted.

System Configuration

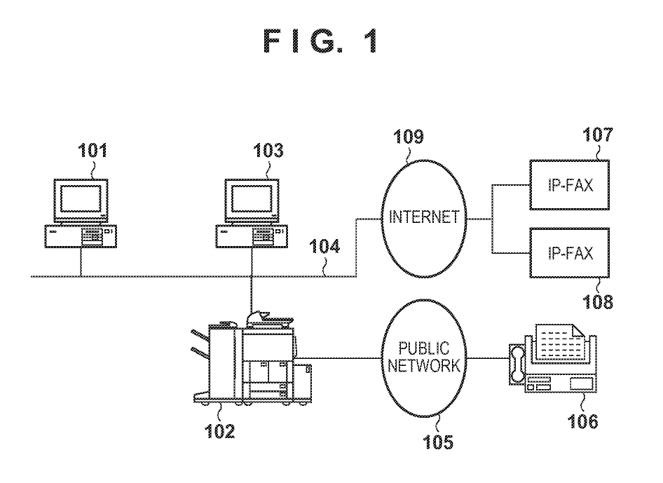

FIG. 1 is a diagram showing the configuration of a data processing system in an embodiment according to the present invention. This system is configured such that a data processing apparatus and an image processing apparatus capable of executing printing, fax transmission/reception and the like can communicate via a network. Also, the image processing apparatus is configured to be able to communicate with another fax machine via a public network. Data processing apparatuses 101 and 103 instruct an image processing apparatus 102 to perform printing and fax transmission. Hereafter, printing and faxing are described as output processing when no distinction is made therebetween. The image processing apparatus 102, which is a multifunction peripheral, is provided with a copy function, a scan function, a fax function, a file transmission function and the like in addition to a printer function. Note that a prescribed operating system (OS) and various types of applications that execute specific functional processing are installed in the data processing apparatuses 101 and 103. Here, the specific functional processing includes word processing, spreadsheet processing, presentation processing, image processing, graphics processing and the like, and the applications respectively have independent data structures (file structures). The OS refers to the identifiers of individual files and issues print instructions to applications corresponding to those identifiers. Hereafter, processing of the OS and an after-mentioned integrated application is assumed to also include fax transmission unless stated otherwise.

An integrated application that integrates and manages various functions that are on the desktop is installed in the data processing apparatuses 101 and 103. Here, the integrated application includes a function of improving printing and faxing operations, a function of managing information, a function of reducing printing costs, a function of improving paper digitization operations, a function for authorization operations using electronic documents, and a function of sharing in-house information. The function of improving printing and faxing operations includes a function of instructing the image processing apparatus 102 to perform output processing of a file in which pieces of application data having different formats are compiled and packaged. In the present embodiment, an example in which the file format (data structure) of compiled document information is PDF (Portable Document Format) will be described as exemplary output processing of a file in which pieces of application data having different formats are compiled and packaged. However, documents need not be PDF documents as long as they are capable of being integrally managed. Also, the applications need not be specific applications.

The above apparatuses are able to communicate information to each other via a LAN 104. The image processing apparatus 102 and a fax machine 106 transmit and receive fax data via a public network 105. The fax machine 106 receives fax data transmitted from the image processing apparatus 102. Also, the image processing apparatus 102 is able to transfer Internet fax data received via the LAN 104 to IP-FAXs 107 and 108. Here, Internet faxing (iFAX) is technology, known as the T.37 and T.38 protocols, for transmitting and receiving image data in fax format attached to an e-mail in accordance with e-mail protocols. SMTP is used as the e-mail transmission protocol, and SMTP and POP3 are used as the e-mail reception protocols. With the T.38 protocol, a fax signal is encoded into an IP fax packet and sent to a gateway at the receiver end over an IP network. The gateway at the receiver end then decodes the IP fax packet into the fax signal, and executes a PSTN call to the facsimile machine at the opposite end.

Hardware Configuration

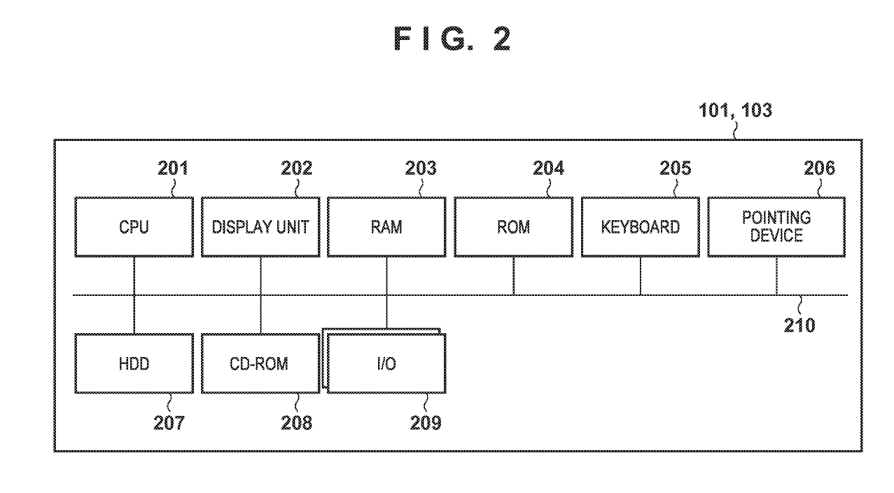

FIG. 2 is a diagram showing the hardware configuration of the data processing apparatuses 101 and 103. As shown in FIG. 2, a keyboard 205 and a pointing device 206 that receive user operation inputs are provided in the data processing apparatuses 101 and 103. Further, the data processing apparatuses 101 and 103 include a display unit 202 that provides visual feedback of output information to a user. Further, storage devices such as a RAM 203, an HDD 207, a ROM 204 and a CD-ROM 208 that store various programs, execution information and the like of the present embodiment are included. Further, an external device connection I/O 209 for performing communication with an external device is included. A CPU 201 executes the various programs. In the present embodiment, the data processing apparatuses 101 and 103 may be connected to a peripheral device by either cable or wireless. The data processing apparatuses 101 and 103 may be configured to connect to the image processing apparatus 102 via the external device connection I/O 209.

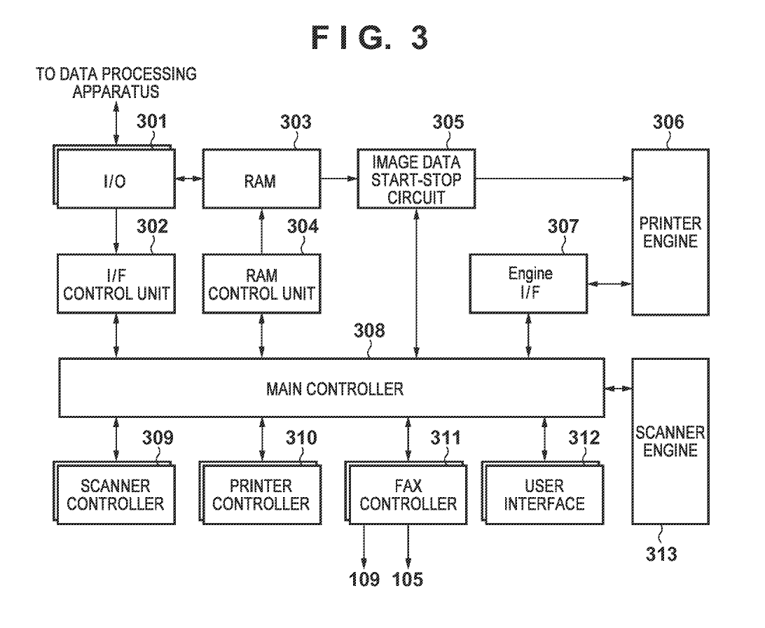

FIG. 3 is a block diagram illustrating the hardware configuration in the image processing apparatus 102. Note that in the present embodiment, a multifunction peripheral (MFP) having a scanner function, a printer function, and a fax function is described. As shown in FIG. 3, an I/O 301 is connected to the data processing apparatuses 101 and 103 via a communication medium such as the network (LAN) 104. A plurality of I/Os 301 may be mounted in order to support a plurality of connection configurations. The image processing apparatus 102 passes device IDs, scanned images and the like to the data processing apparatus 101 or 103 via the I/O 301. Also, the image processing apparatus 102 receives various types of control commands from the data processing apparatus 101 or 103, and executes various types of image processing.

An I/F control unit 302 issues device IDs for processing systems such as the scanner, printer or fax mounted in the image processing apparatus 102. A RAM 303 is a primary storage apparatus that stores images read by a scanner engine 313 and external data such as control commands acquired by the I/O 301. Further, the RAM 303 stores an image expanded by a printer controller 310 before the image is passed to the printer engine 306. A RAM control unit 304 performs allocation management of the RAM 303. An image data start-stop circuit 305 outputs an image imported and expanded by the printer controller 310 or the scanner engine 313 to the printer engine 306.

The printer engine 306 develops the image on a printing medium such as paper. A main controller 308 performs various controls on the printer engine 306 via an engine I/F 307. The main controller 308 is a module that is central to the various controls. The main controller 308 appropriately allocates control languages received from the data processing apparatus 101 or 103 through the I/O 301 to the scanner controller 309, the printer controller 310 and the fax controller 311. Further, the main controller 308 receives instructions from the controllers and a user interface 312, and controls the printer engine 306 and the scanner engine 313.

Consolidating the control interfaces between the main controller 308 and the various controllers enables an expansion board capable of processing plural types of control commands to be mounted in a single peripheral device. Also, the main controller 308 acquires the device IDs of the controllers that are currently configured from the respective controllers and manages the device IDs. The scanner controller 309 converts scan control commands received from the data processing apparatus 101 or 103 into internal execution instructions capable of being interpreted by the main controller 308. Also, the scanner controller 309 converts images read with the scanner engine 313 into scan control commands. The printer controller 310 converts page description languages received from the data processing apparatus 101 or 103 into internal execution commands including expanded images and the like with a page description language capable of being interpreted by the main controller 308. The expanded images are sent to the printer engine 306 and printed on a printing medium.

The fax controller 311 expands fax control languages received from the data processing apparatus 101 or 103 into images, and transfers the images to the fax machine 106 or the IP-FAX 107 or 108 via the public network 105 or the Internet 109. The user interface 312 is used in order to receive instructions from a user, when configuring various settings of the main controller 308 or when executing the scanner function, the printer function or the fax function with the image processing apparatus 102. The scanner engine 313, when instructed by the main controller 308, reads a printed image, converts the read image to an electrical signal, and passes the electrical signal to the main controller 308.

Application Configuration

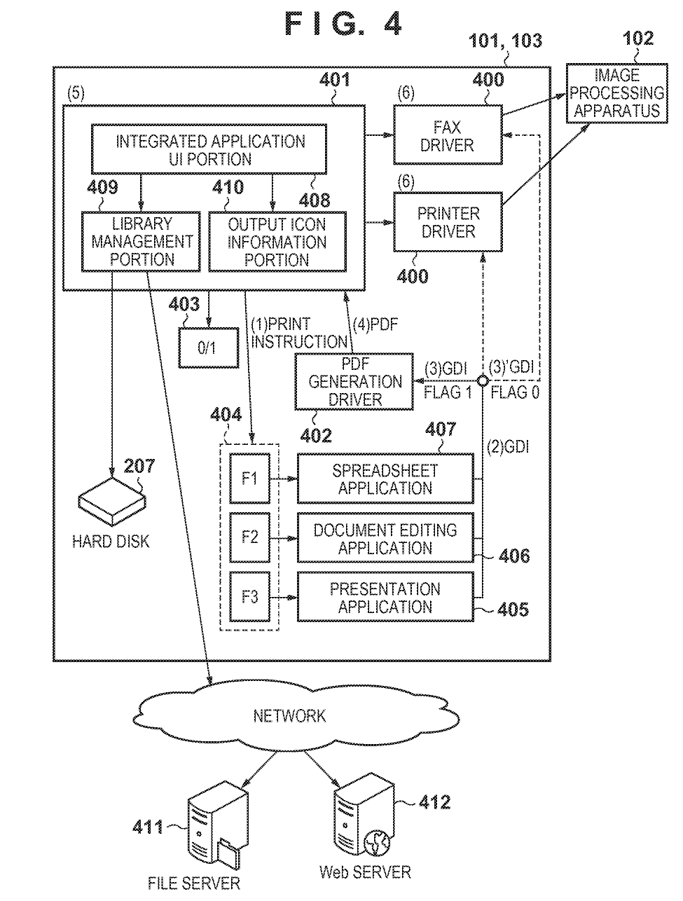

FIG. 4 is a block diagram illustrating the software configuration of the data processing apparatuses 101 and 103. In the present embodiment, an example is described in which batch printing (including batch fax transmission) by an integrated application 401 and individual printing by the applications 405 to 407 are identified, and jobs for output processing in the image processing apparatus 102 are generated. Also, in the present embodiment, the integrated application 401 performs integrated management of documents archived in the file system of an HDD, Web server or the like. A printer driver 400 or a fax driver 400 is installed in the HDD 207 as a system application. Hereafter, description of the printer driver is assumed to also refer to the fax driver unless stated otherwise. The integrated application 401, which is provided with various types of user interfaces for executing the various types of functions mentioned above, receives requests from a user on the desktop of the data processing apparatus 101 or 103, and performs overall management of execution of the various functional processing.

Processing for Switching between Batch Transmission and Individual Transmission

In the present embodiment, the user is able to select in advance, on a properties screen presented by the integrated application 401, whether to perform batch transmission or individual transmission as the print job transmission method. If batch transmission is selected by the user, a transmission method flag 403 holds “1”. If individual transmission is selected by the user, the transmission method flag 403 holds “0”. Note that the transmission method flag 403 is managed in a non-volatile storage apparatus, and is rewritten in accordance with the above transmission method selected on the properties screen. Note that the integrated application 401 directly manages the rewriting of the transmission method flag 403 and the like. The setting method is discussed later.

Pieces of document information 404 selected by the user are passed with a print instruction to the corresponding applications 405 to 407 along with a driver ID (printer driver name of the output destination). Here, the application 405 is a presentation application. The application 405 performs data processing such as processing various types of images, characters, graphics and the like and outputting the processing results on a screen or a display apparatus as still images or presenting a displayed screen as a print result based on instructions from the user. Also, the user is able to update pages sequentially and reversibly in accordance with instructions from the pointing device or the like, and to update pages to be displayed in accordance with requests from a presenter.

The application 406 is a document editing application. The application 406 has a function as a word processor and a function of creating document information by pasting together objects such as graphics and images. The application 407 inputs characters, numbers and the like into displayed cells and executes spreadsheet processing. The application 407, by activating a created macro, is also able to execute processing that involves executing a program that follows a procedure of the macro and displaying the result.

Batch Transmission Processing and Individual Transmission Processing

A PDF generation driver 402 executes conversion processing from rendering information to common document information. The PDF generation driver 402 converts rendering information output by the applications 405, 406 and 407 into common document information in PDF format, in the case where the transmission method flag 403 is “1”. On the other hand, the PDF generation driver 402 controls the applications 405 to 407 such that rendering information (e.g., GDI commands) output by each application is output to the printer driver 400, in the case where the transmission method flag 403 is “0”.

The integrated application 401 receives the PDF document information converted by the PDF generation driver 402 from the rendering information output by the applications 405, 406 and 407, in the case where the transmission method flag 403 is “1”. The integrated application 401 then converts the PDF document information into a binder file that is capable of being batch transmitted by the printer driver 400 as a single job. Note that in the present specification, a binder file is a file containing plural pieces of PDF document information to be batch transmitted. In the present embodiment, processing for converting rendering information (GDI) into PDF document information is executed as an example of the processing for converting from rendering information into PDF common document information that is performed by the PDF generation driver 402. The binder file is then generated from the PDFs.

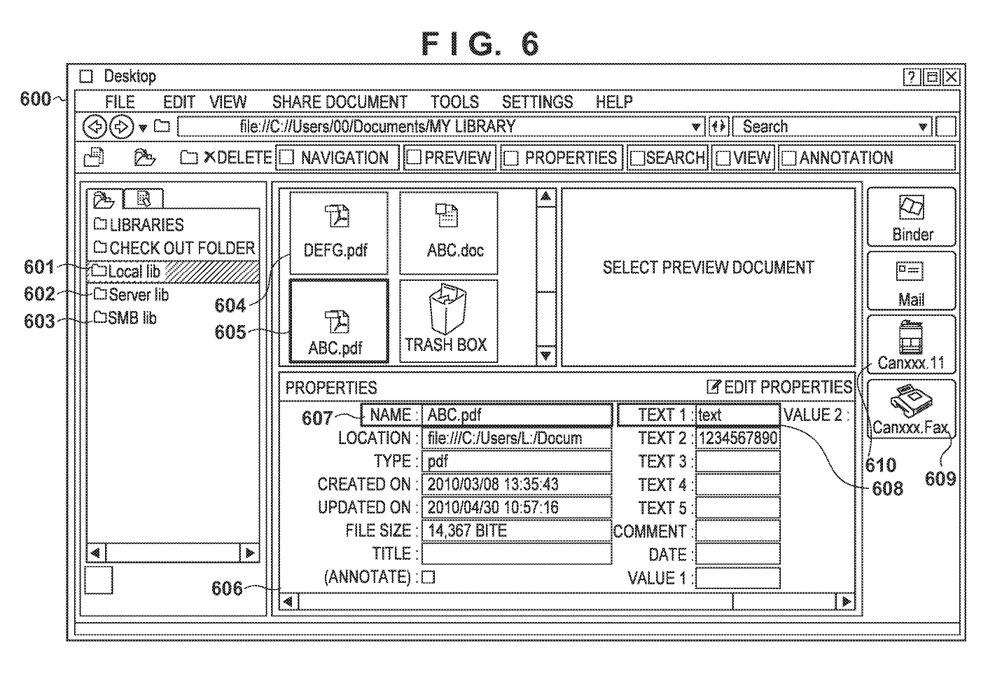

Hereinafter, the processing flow of the integrated application 401 in the data processing apparatuses 101 and 103 is described, with reference to FIG. 4. The integrated application 401 issues a print instruction ((1) in FIG. 4) as a result of the user selecting plural pieces of document information on a UI shown in FIG. 6 with the pointing device 206 or the like and dropping the selected information onto an output icon 609 or 610. Plural pieces of document information are selected and, with one drag-and-drop operation, a fax transmission or print instruction is completed. The output icons are discussed in detail later.

Next, in response to the print instruction ((1) in FIG. 4), the integrated application 401 displays a sequence settings screen for allowing the user to designate the sequence in which the selected pieces of document information are combined. FIG. 8 is a diagram showing the sequence settings screen for setting the sequence in which to combine a plurality of documents. In FIG. 8, document information 821 and 823 represents selected pieces of document information, and changing the sequence in which the selected pieces of document information are combined can be instructed by the user selecting a button 824 or 825. The integrated application 401 is able to acquire the combining sequence designated by the user from the settings on the sequence settings screen shown in FIG. 8. In other words, the user is able to arbitrarily change the combining sequence of the selected pieces of document information, in accordance with a specific rule, such as file identifier order, file date order or file selection order, for example, on the user interface shown in FIG. 6.

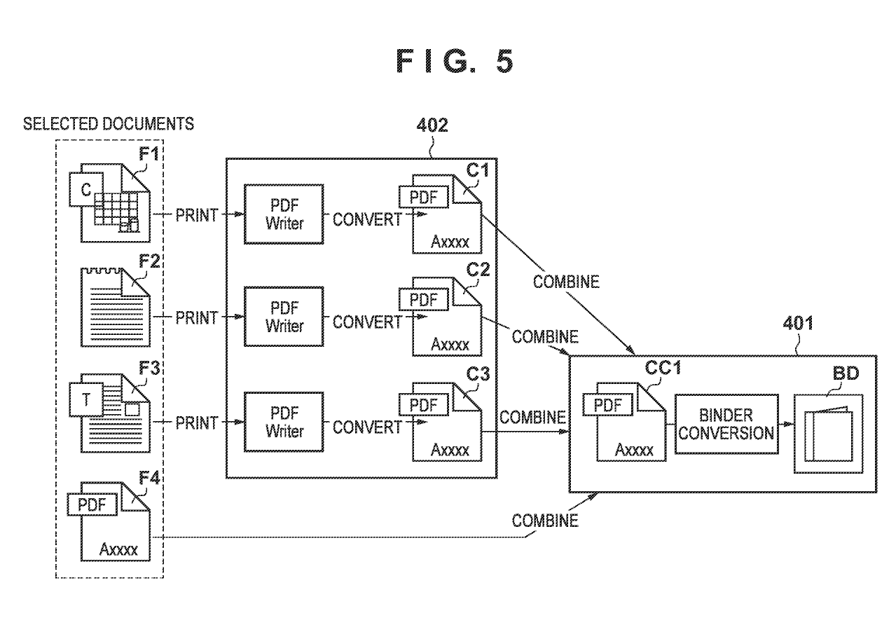

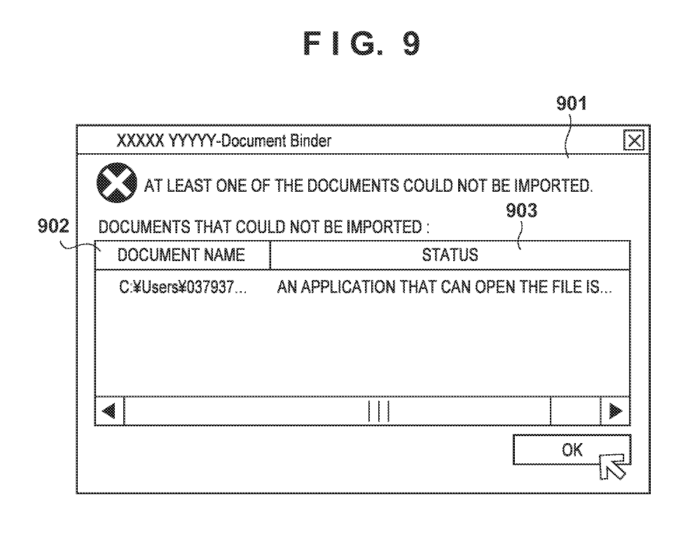

In response to the print instruction ((1) in FIG. 4), the integrated application 401 passes application data corresponding to the selected document information to the different applications 405 to 407. Note that the format of the pieces of application data is supported by the respective applications. The respective pieces of application data are converted into GDI functions (rendering information) ((2) in FIG. 4). Here, application data is, for example, spreadsheet data, document data of a word processing application, or data of presentation software. Here, if the value indicated by the transmission method flag 403 is “1”, the GDI (rendering information) is input to the PDF generation driver 402 ((3) in FIG. 4). The PDF generation driver 402, in response to GDI functions being called, generates PDFs (common document information) from a plurality of file types such as spreadsheets and the like ((4) in FIG. 4). Because two pieces of document information are selected in the example in FIG. 8, two PDFs (common document information) are generated. The integrated application 401 receives the common document information ((4) in FIG. 4) in PDF format from the PDF generation driver 402, and generates binder information BD shown in FIG. 5. Note that information identifying an application capable of PDF conversion is registered in the PDF generation driver 402, and it can be determined whether GDI acquired from each application is convertible to PDF. Also, the integrated application 401 is able to notify error information notified from the PDF generation driver 402 to the user with a warning screen such as shown in FIG. 9.

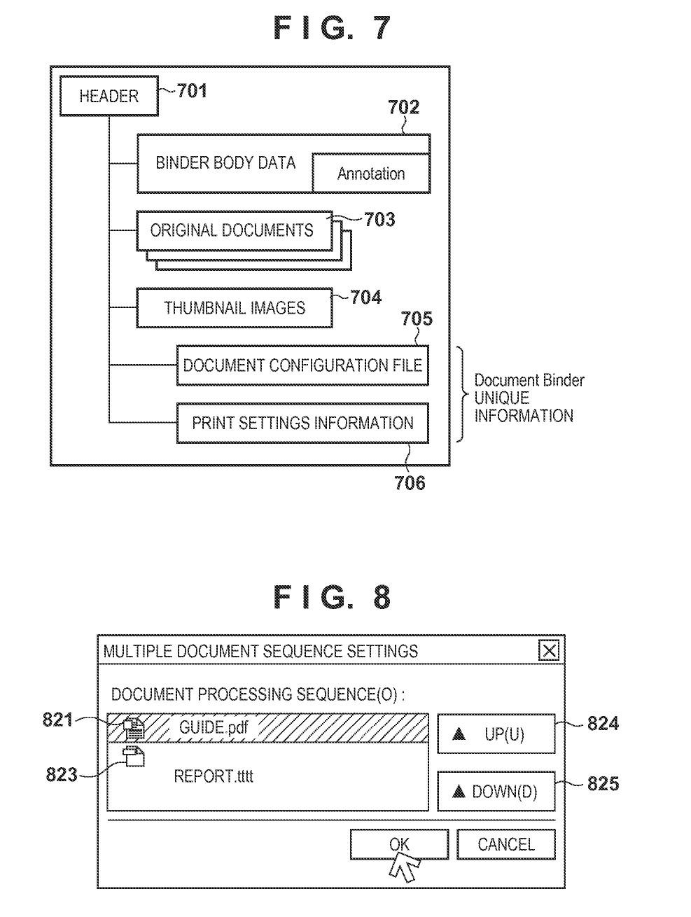

The integrated application 401 stores the PDF data in binder body data in the sequence designated on a UI screen such as shown in FIG. 8. The integrated application 401 stores the pieces of application data that were combined in original document information 703 shown in FIG. 7. This processing may, however, be omitted. Also, the integrated application 401 displays a message shown in FIG. 9 on the display unit 202, in the case where there is application data that cannot be converted to PDF because the required application does not exist. Here, the integrated application 401 may be configured to display a required application name, for example. In the present embodiment, the print settings of PDF data input to the integrated application 401 are fixed, such as paper size: “original”, print method: “single-sided”, and layout: “1-up”. These settings can be preset or changed by the integrated application 401.

This integrated PDF data is again converted to GDI by the integrated application 401. Here, the GDI (rendering information) of integrated PDF data is input to the printer driver 400 called by the integrated application 401 ((5) and (6) in FIG. 4), and transmitted from the printer driver 400 to the image processing apparatus 102. The CPU 201 controls the series of transmission processes for a single job such as the above. The printer driver 400 first generates rendering data based on the received GDI, and packages this rendering data as the data structure of the job defined by the start command and end command of the job. The printer driver 400 then transmits this job data to the image processing apparatus 102.

In the case of fax transmission, the image processing apparatus 102 initially stores a job transmitted from the fax driver 400 in memory. After initiating an outgoing call or an Internet fax negotiation, the image processing apparatus 102 converts (compresses) the image data in accordance with the capability of the fax receiver that acquired the data sent when the fax transmission was initiated, and transmits the converted image data as fax data. Note that JBIG, MH, MR or MMR, for example, is used for the compression.

In the case where the transmission method flag 403 is “0”, the GDI converted using the applications 405 to 407 is output by each application to the printer driver 400. In this case, the GDI is output to the printer driver 400 via the route indicated by (3)′ in FIG. 4. That is, the GDI is directly input to the printer driver 400 from each of the applications 405 to 407. Since the fax driver 400 is thereby called three times in the case of fax transmission, for example, telephone charges for three calls will be incurred in the FAX transmission processing. Note that with the route (3)′ shown in FIG. 4, the applications 405 to 407 obtain the driver ID (printer driver name of the output destination) from the integrated application 401, and independently call the printer driver 400 based on this driver ID.

FIG. 5 is a diagram showing the concept of file generation processing by data processing apparatus. In FIGS. 5, F1 to F4 are pieces of document information selected for printing by the user using a user interface discussed later, and each has a different file format (data structure). Note that the document information F4 has the same file format as that generated by the PDF generation driver 402, and such document information F4 is passed directly to the integrated application 401, with the processing by the PDF generation driver 402 being omitted.

C1 to C3 are all pieces of common document information in PDF format that are generated by the PDF generation driver 402 and passed to the integrated application 401. CC1 is combined document information. CC1 is generated by combining the common document information C1 to C3 generated from the rendering information passed to the integrated application 401 from each application via the PDF generation driver 402 and the document information F4 having a matching file format into a single piece of combined document information. The integrated application 401 then converts the combined document information CC1 into a single piece of binder information BD. Note that the PDF generation driver 402 converts the document information F1 to F3 received from the applications into the common document information C1 to C3 in PDF format, in the process of executing print processing on the document information F1 to F3. The binder information BD generated by the integrated application 401 is passed to the printer driver 400, and a single print job is generated (job generation processing) and transmitted to the image processing apparatus 102.

Binder Configuration

FIG. 7 is a diagram for illustrating the data structure of the binder generated by the integrated application 401 shown in FIG. 4. In FIG. 7, pieces of header data discussed later are tied together and managed in a header 701. Binder body data 702 is data generated by combining data converted to PDF from plural pieces of application data. Original document information 703 corresponds to respective pieces of the above-mentioned application data. The original document information 703 is constituted by a group of different types of data such as spreadsheet, document editing application and presentation application data. Thumbnail picture information 704 is constituted by thumbnail data generated from snapshots of the original document information 703. A document configuration file 705 stores information indicating a chapter structure of the binder body data 702. Here, “chapter structure” denotes a definition indicating that pages X to Y are chapter Z, for example. Print settings information 706 holds settings such as paper size: “original”, print method: “single-sided”, and layout: “1-up”, for example.

The data processing apparatuses 101 and 103 in the present embodiment compress one whole binder into a prescribed compression format (e.g., ZIP), and manage the compressed binder as a single file. Note that the print settings of the fax driver 400 are fixed as paper size: “original”, print method: “single-sided”, and layout: “1-up”. Also, as for the facsimile destination setting, the integrated application 401 displays a transmission settings dialog on the display unit 202 when the user presses a facsimile icon. In the transmission settings dialog, the user is able to designate or select a transmission destination.

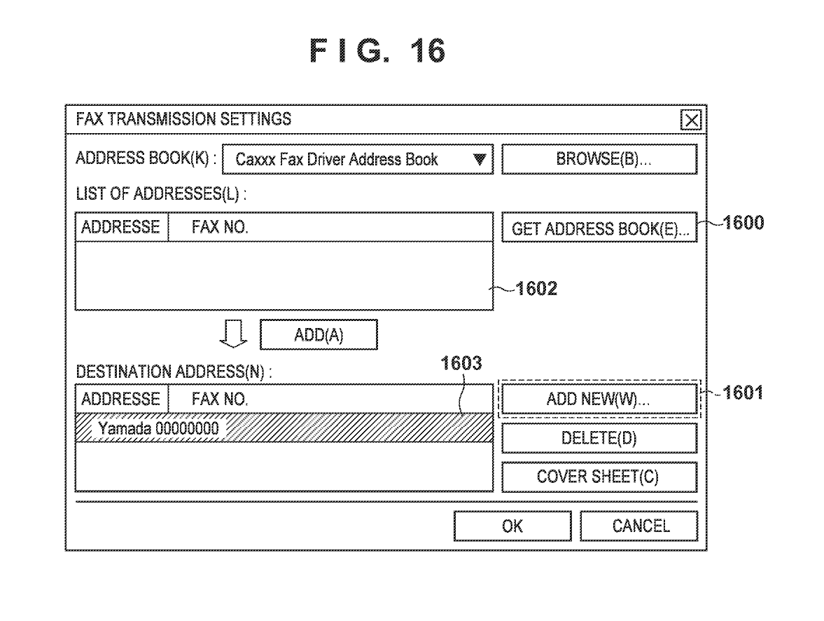

FIG. 16 is a diagram showing a facsimile transmission settings screen. In FIG. 16, when the integrated application 401 detects that a button 1600 has been pressed by the user, the integrated application 401 acquires address book information managed by the image processing apparatus 102. The CPU 201 controls the units so as to display an address book list 1602 that is based on the address book information acquired from the image processing apparatus 102 on the display unit 202. When the integrated application 401 detects that a button 1601 has been pressed by the user, a destination name and a facsimile number are displayed in a destination address field 1603.

Document Management Processing

Document management processing by the integrated application 401 is described next with reference to FIG. 4. The integrated application 401 includes components 408, 409, and 410. An integrated application UI portion 408 constructs the user interface shown in FIG. 6 and receives various input operations from the user. FIG. 6 is a diagram showing an exemplary user interface of the integrated application 401. A window 600 indicates a main window.

A library management portion 409 performs overall management of access to a save area (hereinafter, library) used for document management by the integrated application 401, and various file operations. Libraries 601 to 603 differ according to the type of storage area. One library is a local library that uses, as a save area, the storage area of the local hard disk 207. The local library can only be used by the user utilizing the integrated application 401. Another library is an SMB library that uses, as a save area, a file server 411 using an SMB protocol. The SMB library can be shared for use by users having access rights to the file server 411, if each user defines a library using the integrated application 401. Another library is a Web server library that uses, as a save area, a Web server 412 using an HTTP protocol. The Web server library communicates using a Web service provided by document management software installed on the Web server 412, and executes various file-related operations. The Web server library can be shared for use by users who perform management using the software of Web server 412, if each user defines a library with the integrated application 401.

The library 601 shown in FIG. 6 is an icon displayed when a local library is registered. The library 602 is an icon displayed when an SMB library is registered. The library 603 is an icon displayed when a Web server library is registered. A file list pane 604 displays files and folders that are stored in a selected save location. A selection frame 605 indicates that the respective file has been selected. A property pane 606 displays the properties (attribute information) of the file or folder selected by the selection frame 605. Properties consist of items (e.g., name, date, size) and the values of the items (e.g., May 10, 500 bytes). In FIG. 6, a value “ABC.pdf” is set for a “name” item 607. Also, a value “text” is set for a “text 1” item 608. The number of items that can be set is defined for each library, and is variable depending on the type of library. For example, in the case of the local library, the same items as the properties that are settable in the file system of the operating system can be set. In the case of the Web server library, the same items as the properties that are arbitrarily customized by settings in the Web server 412 can be set. A library management portion 409 manages property items as capabilities of the various libraries, and undertakes the role of returning property items and value information to the integrated application UI portion 408 in response to designation of a library. Also, the library management portion 409 sets values designated by the integrated application UI portion 408 in the property items.

Output Icon Configuration

An output icon information portion 410 manages output icon settings of the integrated application 401. The output icon 609 or 610 shown in FIG. 6 has link information to an execution file of the printer driver 400 or fax driver 400 or any of the various types of applications installed on the data processing apparatuses 101 and 103. Also, the output icon 609 or 610 is linked to one of a driver or an application. The user selects arbitrary document information in the file list pane of the integrated application 401, and presses the output icon 609 or 610 or drags and drops the selected document information onto the output icon 609 or 610. The selected document information is then output by the driver or processed by the application registered in the output icon 609 or 610. Note that the same applies in the case where plural pieces of document information are selected in file list view.

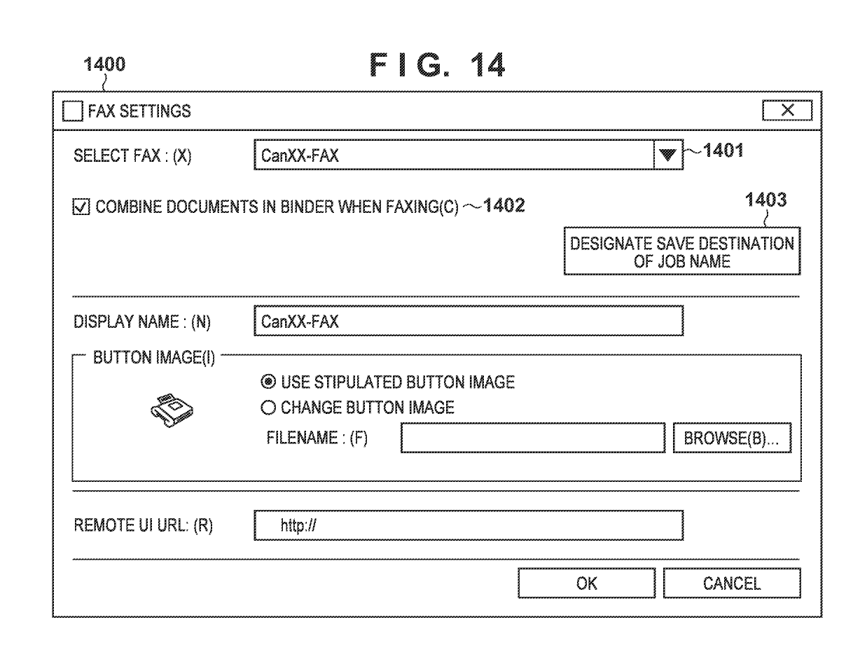

FIG. 14 is a diagram showing an exemplary UI for registering the output icon 609 or 610 on the integrated application 401. An output icon settings dialog 1400 can be displayed from a menu item, tool button or the like of the integrated application 401. The output icon settings dialog 1400 is for setting an output icon having a link to a fax driver, although a similar method can be used in the case of a printer driver or an application. By designating an arbitrary fax driver installed on the data processing apparatuses 101 and 103 in an item 1401, a link to a fax driver can be set for an output icon. An item 1402 is a check box for setting the transmission method flag 403 corresponding to whether the aforementioned plurality of documents will be batch transmitted or individually transmitted. The transmission method flag is set to “1” if the check box is ON, and to “0” if the check box is OFF. Also, a display name and an icon image can be designated for an output icon, in addition to a link in a printer driver or an application. Further, whether to store a job name arbitrarily designated at the time of batch transmission in the properties of the documents that are combined can be set for an output icon. An item 1403 is a button for displaying a UI for setting the save destination of the job name discussed later.

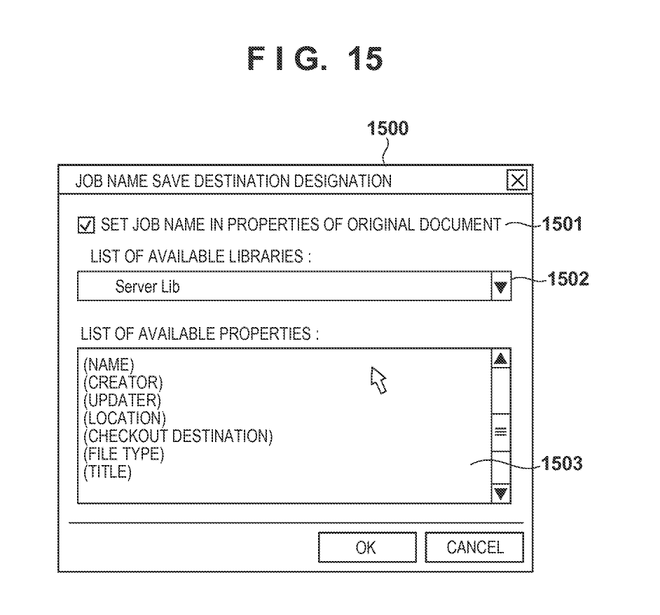

FIG. 15 is a diagram showing an exemplary UI for setting the save destination of a job name. As a result of settings configured on this UI, a job name is stored in an arbitrary property of each of the documents that were combined, in the case where a plurality of files are batch transmitted by an output icon. A job name save destination settings dialog 1500 can be displayed from the settings dialog 1400 of the output icon 609 or 610. An item 1501 is a check box for setting whether to store a job name in a property value of each of the documents that were combined. Setting the check box to ON enables the job name to be stored in a property value of each of the documents that are combined. Items 1502 and 1503 are controls for designating a property item for storing the job name. Items 1502 and 1503 are activated and can be set when the check box item 1501 is set to ON. The item 1502 is a control for designating a library registered in the integrated application 401. In the present embodiment, because the property items change depending on the type of library, a library needs to be designated in order to specify property items. An item 1503 is a control for designating a property item for storing the job name. A list of property items set in the library designated in the item 1502 is displayed in the item 1503. An arbitrary item is designated from the displayed list of property items as a property item for storing the job name.

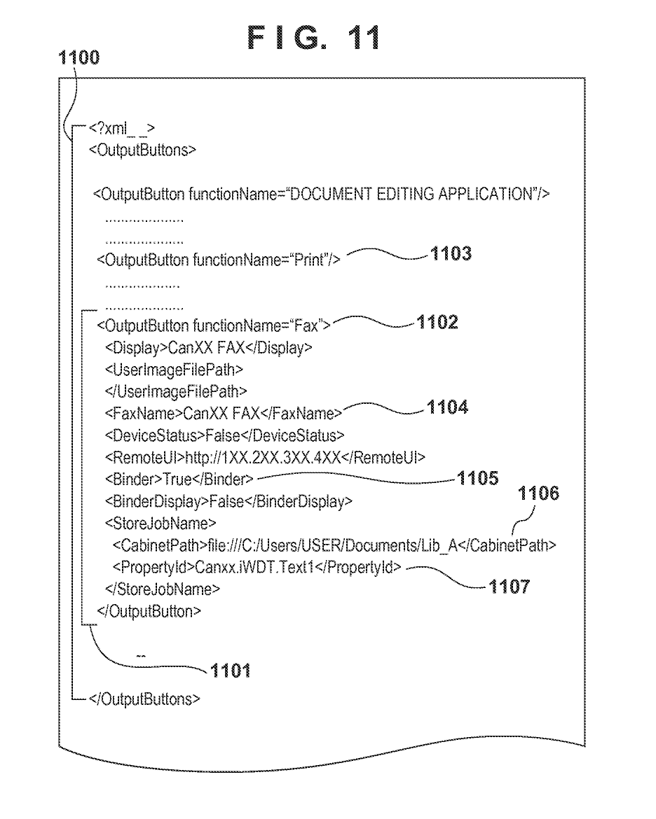

FIG. 11 is a diagram showing exemplary output icon settings information that is set with the aforementioned method. The settings information is held in a file format such as XML, and defines the setting values of each icon. The output icon information portion 410 is able to return icon information to the integrated application 401, with reference to this settings information file. Reference numeral 1100 in FIG. 11 denotes tags defining the output icons as a whole, and the settings of all icons registered in the integrated application 401 are written within these tags. Reference numeral 1101 in FIG. 11 denotes tags defining a single output icon linked to a fax driver. Reference numeral 1102 in FIG. 11 denotes a tag indicating the type of output icon, and has a value “Fax” since the icon is linked to a fax driver. An icon linked to a printer driver will have a value “Print” as denoted by reference numeral 1103, and similarly holds various settings that are described below. Reference numeral 1104 in FIG. 11 denotes a tag indicating the fax driver name of the link. Reference numeral 1105 in FIG. 11 denotes a tag indicating the setting of the transmission method flag as to whether to perform batch transmission or individual transmission, with a “True” value signifying batch transmission (transmission method flag is “1”). Reference numerals 1106 and 1107 in FIG. 11 denote tags indicating settings as to whether to store a job name in a property item of each of the documents that were combined, and the existence of values in these tags is regarded as indicating that storage of a job name is set. Reference numeral 1106 in FIG. 11 denotes a tag indicating a path of the library targeted for storing the job name. Reference numeral 1107 in FIG. 11 denotes a tag indicating the ID of the property item targeted for storing the job name.

Import Error Processing

FIG. 9 is a diagram showing an exemplary user interface that can be displayed on the data processing apparatuses 101 and 103. FIG. 9 is a warning screen for displaying to the user that an error has occurred in import processing on common document information. Reference numeral 901 in FIG. 9 denotes an error message indicating that an application supporting the document information to be printed is not installed. At this time, a document name 902 and a status 903 are also displayed as document information that could not be imported by the PDF generation driver 402. An import error occurs in the case where an application that is able to convert the application data (document information) to be printed into GDI to be input to a PDF Writer does not exist, and this fact is displayed as shown in FIG. 9. In the case where a user wants to continue the processing of the document information, the corresponding application is newly installed.

Job Name Designation and Job Name Storage Processing Flow

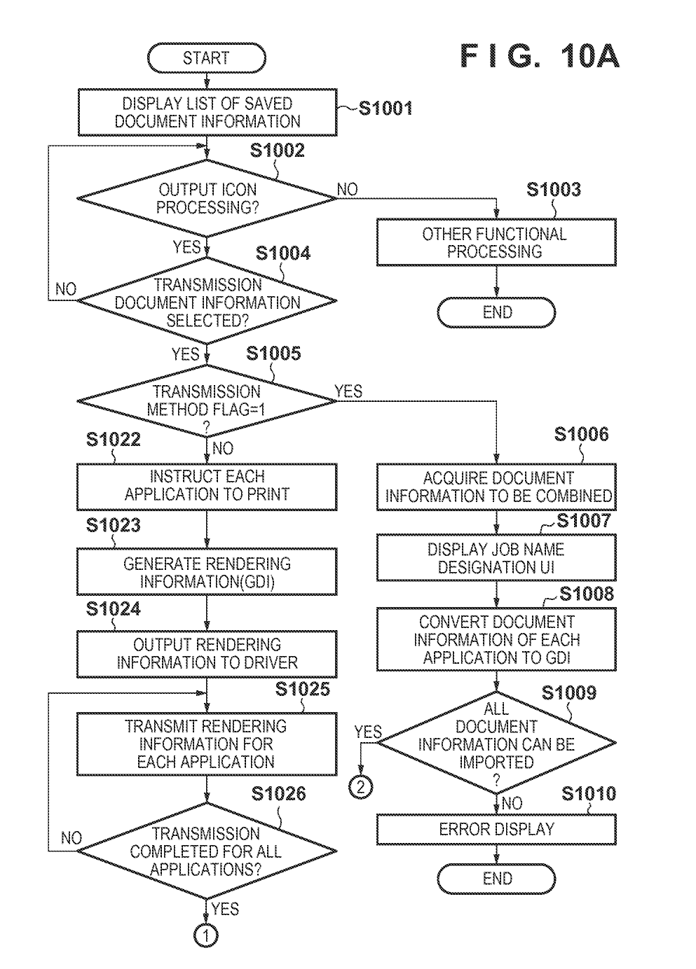

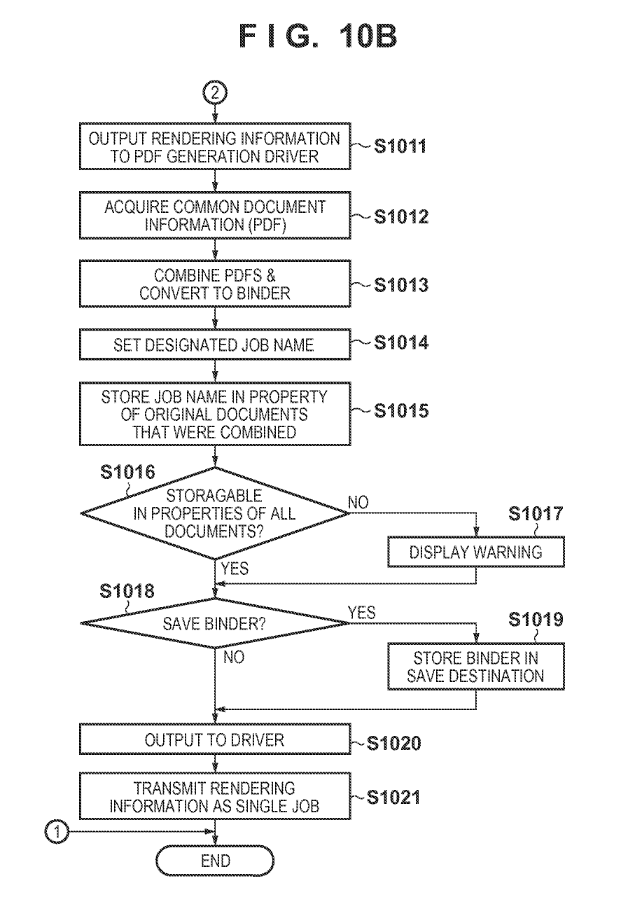

FIG. 10A and 10B are flowcharts showing an exemplary procedure of data processing in the data processing apparatus illustrating the present embodiment. FIG. 10A and 10B show a procedure of job processing by the integrated application 401. Specifically, a print instruction for document information selected by the user on the list screen is received, and in the case of batch transmission, a job name is designated, and the designated job name is stored in a designated property item of each selected document. In batch transmission processing, a print instruction is issued to applications supporting the pieces of document information selected by the user, the selected document information is converted to common document information (PDF) by the PDF generation driver 402, and the pieces of common document information are combined and converted to a single binder. Note that the processing shown in FIG. 10A and 10B is realized as a result of the integrated application 401, drivers, and the like stored in the ROM 204 and the HDD 207 being loaded into the RAM 203 and executed by the CPU 201. Hereafter, unless stated otherwise, it is assumed that the processing is executed by the integrated application 401, and information that is temporarily stored is written into the RAM 203. Also, this processing is executed on receipt of a function selection instruction given by the user to the integrated application 401 shown in FIG. 4.

First, at S1001, the integrated application 401 displays the document list screen 600 for selecting document information on the display unit 202. Note that icons that enable attributes of the document information to be identified and filenames containing identifiers thereof are displayed on the document list screen 600. At S1002, the integrated application 401 waits for a processing event from the user, and determines whether the type of function received from the user is output processing by the output icon 609 or 610. Here, in the case where it is determined that the function received from the user is not output processing by the output icon 609 or 610, the processing advances to S1003, where the integrated application 401 performs the other processing of the function received from the user, and ends the processing.

On the other hand, when it is determined at S1002 that the type of function received from the user is output processing by the output icon 609 or 610, the processing advances to S1004. At S1004, the integrated application 401 determines whether one or more pieces of document information have been selected on the document list screen 600. Here, the user is able to simultaneously select different types of document information using a drag operation. If the CPU 201 determines at S1004 that no documents have been selected, the processing advances to S1002, where the integrated application 401 waits for a document to be selected. On the other hand, if it is determined at S1004 that one or more documents have being selected, the processing advances to S1005.

At S1005, the integrated application 401 determines whether the transmission method flag is “1” from the settings information of the output icon 609 or 610 designated at S1002. Specifically, the integrated application 401 acquires settings information of the output icon 609 or 610 designated at S1002 such as shown in FIG. 11 from the output icon information portion 410, and stores the acquired settings information in memory. The integrated application 401 extracts the tag information of 1105 in FIG. 11 from the acquired settings information of the output icon. If the value of the tag shown in 1105 of FIG. 11 is “True”, the integrated application 401 determines that the transmission settings flag is “1”, and executes the processing from S1006 onward.

On the other hand, if the value of the tag shown in 1105 of FIG. 11 is “False”, the integrated application 401 determines that the transmission method flag is “0”, and executes the processing from S1022 onward. Note that at S1022 onward, GDI is output to the printer driver 400 by each application, and transmission processing is executed. Also, the processing from S1006 onward includes processing in which the PDF generation driver 402 converts GDI generated by a plurality of applications and processing in which the integrated application 401 combines individual PDF data into a single PDF file. Further, the processing from S1006 onward includes job name designation processing and processing for storing a job name for each of the documents that were combined. Further, the processing from S1006 onward includes processing for converting combined PDF files into a binder file and processing for transmitting GDI generated from the converted PDF data as a single job. Hereinafter, the processing from S1006 onward is discussed in detail.

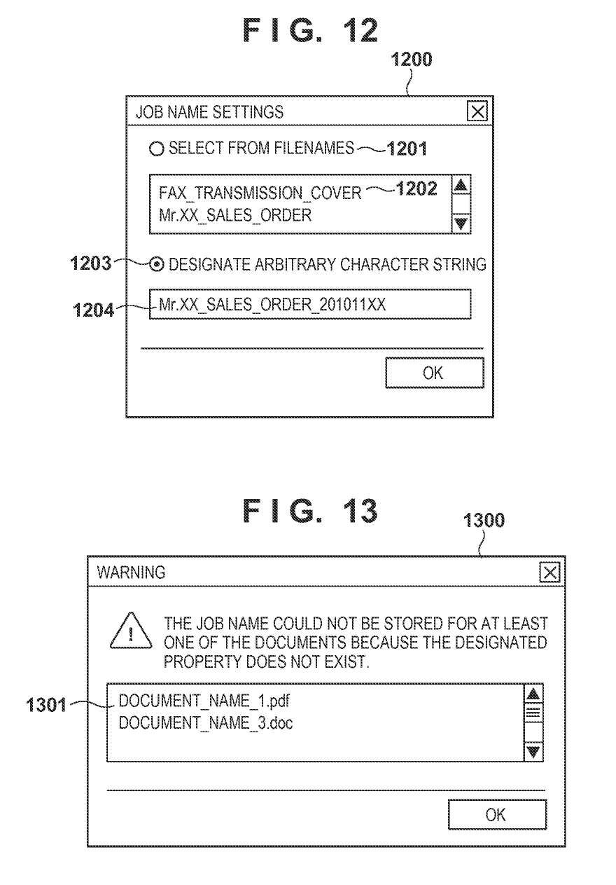

At S1006, the integrated application 401 acquires the document information selected at S1004. The integrated application 401 acquires the save locations and filenames of all of the documents selected at S1004 via the library management portion 409, and temporarily stores the acquired save locations and filenames in memory as listed data. At S1007, the integrated application 401 displays a job name designation UI for designating a job name of the job for combining and outputting by the integrated application 401. FIG. 12 is a diagram showing an exemplary job name designation UI. A screen 1200 indicates the entire job name designation UI. An item 1201 is a radio button that enables a job name to be selected from the filenames acquired at S1006. An item 1202 is a list box displaying the filenames acquired at S1006, and is only active when the item 1201 has been selected. If the acquired filenames relate to a plurality of files, a plurality of filenames will be displayed in list form. An item 1203 is a radio button for enabling a job name to be designated with an arbitrary character string. An item 1204 is a text box for inputting an arbitrary character string, and is only active when the item 1203 has been selected. By selecting a filename listed in the item 1202 and pressing the OK button, the selected filename can be designated as the job name. Here, a configuration may be adopted in which a plurality of filenames are simultaneously selected, the filenames are combined to generate a character string, and the character string is designated as the job name. The integrated application 401 acquires the job name character string designated on the job name designation UI, and temporarily stores the acquired character string in memory.

At S1008, the CPU 201 issues a print instruction to the applications supporting the pieces of document information selected by the user, via the integrated application 401. The CPU 201 executes the applications and generates GDI commands (rendering information) from the document information. Next, at S1009, the integrated application 401 determines whether the GDI commands of all of the pieces of document information to be printed can be imported to the PDF generation driver 402. Here, the processing advances to S1011 if it is determined that all of the rendering information can be imported to the PDF generation driver 402. On the other hand, the processing advances to S1010 if it is determined that the rendering information of any one piece of document information cannot be imported. Note that whether rendering information can be imported or not is determined with reference to information identifying whether the PDF generation driver 402 can convert the GDI of the applications to PDF data, attributes of the applications, and the like. Additionally, S1009 is realized by determining whether applications supporting the document information to be printed are installed. Also, even if applications supporting the document information to be printed are installed, the integrated application 401 determines that rendering information cannot be imported, in the case where an application was not able to make rendering information due to a print error. At this time, because a print error notification is issued to the integrated application 401 by the application, S1009 is realized in accordance with the notification. At S1010, the integrated application 401 then displays a UI such as shown in FIG. 9 on the display unit 202 and notifies the document information with respect to which an import error has occurred to the user, before ending this processing. The details of FIG. 9 are as aforementioned.

At S1011, the rendering information generated from the selected pieces of document information is imported to the PDF generation driver 402. At S1012, the CPU 201 outputs common document information (PDF) converted by the PDF generation driver 402 to the integrated application 401. Note that the processing also advances to S1010 in the case where common document information could not be generated for any one piece of document information due to an error in the PDF generation driver 402 at the stage of S1012. The error message in this case, differently from FIG. 9, indicates that there is an error in the PDF generation driver 402. At S1013, the CPU 201 executes combination processing for combining the pieces of common document information into a single common document and binder conversion processing for converting the combined document information into a binder file by executing the integrated application 401. At S1014, the integrated application 401 acquires the job name stored at S1007, and sets the acquired job name in the binder file generated at S1013 as the job name at the time of output to a driver.

At S1015, the integrated application 401 acquires the document information list stored at S1006, and sets the job name stored at S1007 in the designated property of each document. A specific method will be described. The integrated application 401 extracts information on the storage location of the job name such as indicated by 1106 and 1107 in FIG. 11 from output icon settings information such as shown in FIG. 11 that was acquired at S1005. The integrated application 401 then determines, for each document displayed in the acquired document information list, whether the property item designated as the job name storage location exists, via the library management portion 409. Here, if it is determined that the job name storage location does exist, the integrated application 401 sets the job name stored at S1007 in the property item serving as the storage location of the job name, via the library management portion 409. On the other hand, if it is determined that the storage location of the job name does not exist, that document information (save destination, filename) is listed up and stored in memory. Once the job name setting processing ends for all of the pieces of the document information, the processing advances to S1016.

At S1016, the integrated application 401 determines whether the job name has been stored for all of the documents in the document list stored at S1006. This determination is performed based on whether a document information list temporarily stored in S1015 exists. If it is determined that a document information list does not exist, it is determined that the job name has been stored for all of the documents, and the processing advances to S1018. On the other hand, if it is determined that a document information list exists, it is determined that the job name could not be stored, and the processing advances to S1017.

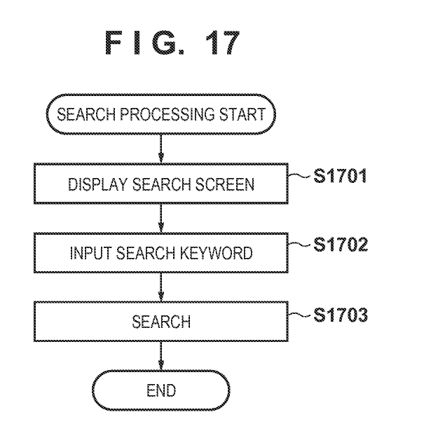

At S1017, the integrated application 401 displays a warning indicating that the job name could not be stored in the property item. FIG. 13 is a diagram showing an exemplary warning message. A screen 1300 indicates the entire warning message UI. An item 1301 is a list box indicating document names for which the job name could not be stored. In the case where a plurality of such documents exist, a plurality of document names are listed. Although the document names are displayed in list form in FIG. 13, a configuration may be adopted in which path information including the save destination of the document is displayed. Note that the integrated application 401 displays the properties screen of FIG. 6 for the documents for which the warning was given, as a result of an OK button being pressed on the warning display screen of FIG. 13. As a result, the user is able to input the job name of the job for combining and outputting using the properties screen of FIG. 6, and search for combined documents using the job name of the job for combining and outputting. Note that a specific method of searching is discussed later with FIG. 17. At S1018, the integrated application 401 determines whether to store the binder file generated at S1013 in an arbitrary file path. In the case where this processing is omitted, the processing advances to S1020. The binder generated at S1013 is data temporarily created at the time of the output processing of an output icon. For that reason, in the present embodiment, an option function for creating and saving a binder file in an arbitrary file system may be provided, in consideration of the case where a transmission error or the like occurs and retransmission is performed. This could be realized by a configuration in which a flag for executing this option can be set on a UI for registering output icons such as shown in FIG. 14, and “True” or “False” is held in output icon settings information such as shown in FIG. 11. At S1018, the integrated application 401 acquires information on the option execution flag from the output icon settings information acquired at S1005, and, if the value is “True”, determines to save the binder and advances to S1019. On the other hand, if the value is “False”, the integrated application 401 determines not to save the binder, and advances to S1020.

At S1019, the integrated application 401 stores the binder file generated at S1013 in an arbitrary file path. The integrated application 401 displays a save destination settings dialog and saves the binder file generated at S1013 in a save destination designated by the user. A configuration may be adopted in which the binder file is stored in a save destination designated by the integrated application 401 in advance, instead of the method of allowing the user to designate the save destination each time. The job name stored at S1007 is acquired and set as the filename at the time of saving the binder.

In S1020, the CPU 201 outputs rendering information that is based on the binder file generated by the integrated application 401 to the printer driver 400 associated with the output icon designated at S1002. At S1021, the printer driver 400 transmits the rendering information of the single job received from the integrated application 401 to the image processing apparatus 102 corresponding to the printer driver and ends the processing. On the other hand, the processing from S1022 onward is the print processing of each application. First, the CPU 201 outputs a print instruction that includes a driver ID (printer driver name of output destination) to the applications 405 to 407 supporting the document information selected by the user via the integrated application 401.

Next, at S1023, the CPU 201 executes each application supporting the selected document information, and generates rendering information. At S1024, the CPU 201 then outputs the rendering information generated by the applications 405 to 407 to the driver 400 along with the driver ID (printer driver name of output destination). At S1025, the CPU 201 then transmits the rendering information to the image processing apparatus 102 as a job of each application via the printer driver 400. Accordingly, if three files have been selected by the user, job transmission processing is repeated three times.

At S1026, the CPU 201 then determines whether the processing for transmitting the rendering information of all of the applications to the image processing apparatus 102 via the driver 400 has been completed. Here, if it is determined that transmission of rendering information by each application has not been completed, the processing returns to S1025 and the processing for transmitting the rendering information by the applications is repeated. On the other hand, the processing is ended if it is determined that transmission of rendering information by each application has been completed.

FIG. 17 is a flowchart showing a procedure of processing for searching for original documents that were combined based on a job name, after the job name of a job for combining and outputting according to the processing shown in FIG. 10A and 10B has been set in a property item of each of the documents that were combined. This processing is executed by the CPU 201 of the data processing apparatuses 101 and 103, for example. First, in S1701, the CPU 201 displays a search display screen on the display unit 202. Next, in S1702, the user inputs a keyword to be searched for on the search display screen. In this processing, the user inputs the job name of the job for combining and outputting that was set on the screen shown in FIG. 12 as the search keyword. Next, at S1703, the CPU 201 searches the various libraries for documents having a name that matches the input search keyword in a property item. Here, the various libraries are the local library, SMB library, and Web server library described in FIG. 6. Finally, the CPU 201 displays the search results on the display unit 202.

According to the present embodiment, pieces of document information corresponding to a plurality of applications that are simultaneously selected by a user from a list of document information created by executing different types of applications managed by the integrated application 401 can be transmitted as a single job. Also, when transmitting documents as a single job, an arbitrary job name designated by the user can be set, and the job name can further be set in the properties of the selected documents that were combined. In other words, the task of tracing jobs that have been transmitted is greatly alleviated as a result of arbitrary job names designated by the user being used. Also, as a result of a job name being set in a property of the original documents that was used at the time of transmission, a search can be performed using the job name as a keyword in the case where the user wants to confirm the documents that were combined after the job has been transmitted, and the user's confirmation task is greatly alleviated. Also, although a job name was described in the present embodiment, an ID or the like may be used instead of a job name, as long as the information is identification information that enables a plurality of jobs to be identified.

Note that although a configuration in which PDF data generated by the PDF generation driver 402 is output to the integrated application 401 was adopted in the above embodiment, a configuration may be adopted in which PDF data is displayed as thumbnails or a list. Further, a configuration may then be adopted in which the converted PDF data of each page can be previewed before being converted to a single PDF file, and the PDF data of pages selected by the user can be deleted from the combined PDF file if necessary.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-082190, filed Apr. 1, 2011, which is hereby incorporated by reference herein in its entirety.

What is claimed is:

1. A data processing apparatus that executes image processing on a file, comprising:
a file generating unit configured to combine a plurality of files selected by a user to generate a single file;
a first setting unit configured to set identification information with respect to the single file generated by the file generating unit; and
a second setting unit configured to set the identification information with respect to each of the plurality of files that are combined.

2. The data processing apparatus according to claim 1, the apparatus further comprising:
a receiving unit configured to receive a job name set by the user as the identification information, and
wherein the second setting unit sets the job name received by the receiving unit as attribute information of each of the plurality of files.

3. The data processing apparatus according to claim 1, further comprising:
a search unit configured to search for each of the plurality of files, based on the identification information.

4. The data processing apparatus according to claim 1, the apparatus comprising:
a transmitting unit configured to transmit a job for print processing to be executed on the single file to a printing apparatus.

5. A data processing method executed in a data processing apparatus that executes image processing on a file, comprising:
a file generating step of combining a plurality of files selected by a user to generate a single file;
a first setting step of setting identification information with respect to the single file generated in the file generating step; and
a second setting step of setting the identification information with respect to each of the plurality of files that are combined.

6. The data processing method according to claim 5, the method further comprising:
a receiving step of receiving the job name set by the user as the identification information, and
wherein the second setting step comprises setting the job name received in the receiving step as attribute information of each of the plurality of files.

7. The data processing method according to claim 5, further comprising:
a search step of searching for each of the plurality of files, based on the identification information.

8. The data processing method according to claim 5, the method further comprising:
a transmitting step of transmitting a job for print processing to be executed on the single file to a printing apparatus.

9. A storage medium storing a program for executing image processing on a file, the program causing a computer to execute:
a file generating step of combining a plurality of files selected by a user to generate a single file;
a first setting step of setting identification information with respect to the single file generated in the file generating step; and
a second setting step of setting the identification information with respect to each of the plurality of files that are combined.

10. The storage medium according to claim 9, the program further causes the computer to execute:
a receiving step of receiving the job name set by the user as the identification information, and
the second setting step comprises setting the job name received in the receiving step as attribute information of each of the plurality of files.

11. The storage medium according to claim 9, the program further causes the computer to execute:
a search step of searching for each of the plurality of files, based on the identification information.

12. The storage medium according to claim 9, the program further causes the computer to execute:
a transmitting step of transmitting a job for print processing to be executed on the single file to a printing apparatus.
